(19) United States
(12) Patent Application Publication
(10) Pub. No.: US 2025/0200281 A1
(43) Pub. Date: Jun. 19, 2025

(54) Artificial Intelligence Driven Document Analysis and Recommendations

(71) Applicant: Pienomial Inc., Rockville, MD (US)

(72) Inventors: Sanat MOHANTY, Rockville, MD (US); Omkar Krishnat PATIL, Kolhapur (IN)

(73) Assignee: Pienomial Inc., Rockville, MD (US)

(21) Appl. No.: 18/540,297

(22) Filed: Dec. 14, 2023

(51) Int. Cl. G06F 40/279; G06F 40/197; G06V 30/41

(52) U.S. Cl. CPC G06F 40/279; G06F 40/197; G06V 30/41

(57) ABSTRACT

A data processing system implements obtaining an image of a document and an indication of one or more content items to generate; analyzing the image of the document to generate a textual representation of contents of the document in the image; constructing a query based on the textual representation; analyzing the query using a second machine learning model to obtain embeddings representing one or more categories of information represented in the query; searching a knowledge graph based on the query embeddings to obtain results of the query; providing the query results to a content generation unit to generate the one or more content items based on the results of the query; and obtaining the one or more content items from the content generate unit.

### BACKGROUND

Various events, such as meeting, conferences, and presentations, may be associated with documents, such as but not limited to posters, flyers, brochures, presentation slides, papers and/or other type of content. Attendees to such events and/or others considering attending such events are frequently presented with such documents and are often curious about learning more about the subject matter of the event. These documents may include links to a website and/or social media of a host or presenter of such events. However, the attendees or potential attendees may wish to obtain a more in-depth analysis of the subject matter of the document but are unsure where to obtain such information and manually searching for and analyzing such information is a time-consuming manual process. Hence, there is a need for improved systems and methods for automating the analysis and generation of content based on this analysis.

### SUMMARY

An example data processing system according to the disclosure includes a processor and a machine-readable medium storing executable instructions. The instructions when executed cause the processor alone or in combination with other processors to perform operations including obtaining an image of a document and an indication of one or more content items to generate based on content of the document; analyzing the image of the document using a first machine learning model trained to generate a textual representation of contents of the document in the image; constructing a query based on the textual representation of the contents of the document using a query processing unit, the query processing unit extracting information from the textual representation of the content and formatting the information according to a query format; analyzing the query using a second machine learning model to obtain embeddings representing one or more categories of information represented in the query; searching a knowledge graph based on the query embeddings to obtain results of the query, the knowledge graph comprising embeddings representing one or more categories of information associated with each of a plurality of content items, the results of the query comprising content related to the one or more categories of information represented in the query; providing the query results to a content generation unit to generate the one or more content items based on the results of the query; and obtaining the one or more content items from the content generate unit.

An example method implemented in a data processing system for generating electronic content includes obtaining an image of a document and an indication of one or more content items to generate based on content of the document; analyzing the image of the document using a first machine learning model trained to generate a textual representation of contents of the document in the image; constructing a query based on the textual representation of the contents of the document using a query processing unit, the query processing unit extracting information from the textual representation of the content and formatting the information according to a query format; analyzing the query using a second machine learning model to obtain embeddings representing one or more categories of information represented in the query; searching a knowledge graph based on the query embeddings to obtain results of the query, the knowledge graph comprising embeddings representing one or more categories of information associated with each of a plurality of content items, the results of the query comprising content related to the one or more categories of information represented in the query; providing the query results to a content generation unit to generate the one or more content items based on the results of the query; and obtaining the one or more content items from the content generate unit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIG. 2 is a diagram of an example implementation of the content generation unit shown in FIG. 1.

FIG. 3 is a diagram of an example knowledge graph unit shown in FIG. 1.

FIG. 4 is a diagram of an example content builder unit shown in FIG. 3.

FIG. 5A-5F are diagrams of an example user interface an application that implements the techniques herein.

FIG. 6 is a flow diagram of an example process for generating content according to the techniques provided herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for Artificial Intelligence (AI) driven document analysis and recommendations are provided. These techniques provide a technical solution for automating the analysis and generation of content based on this analysis. These techniques implement an information analysis and content recommendation platform (IACRP) that accurately acquires, assesses, compares, and analyzes large volumes of data based on information extracted from an image of a document and provides content recommendations and analysis. The IACRP utilizes an image-to-text machine learning model that extracts textual content from an image of a document and/or other machine learning models to extract other content included in the document, such as images, graphs, charts, tables, and/or other elements of the document to determine a subject matter of the document. The IACRP utilizes the information extracted from the document to search for relevant content and to analyze the content to provide various types of recommendations and content to the user. The search is facilitated by a knowledge graph implemented by the IACRP in some implementations. The knowledge graph is based on content items from numerous data sources to facilitate searching for and analyzing relevant content based on the contents of the knowledge graph.

The IACRP implements various AI models that facilitate building and searching the knowledge graph. The knowledge graph is generated using an encoder transformer algorithm to create vector embeddings from content items from numerous public and/or private data sources to generate vector embeddings representing each of these content items. The encoder transformer algorithm is implemented using the encoder or encoders of one or more encoder-decoder type machine learning models. The data sources may include but are not limited to press releases, news articles, documents submitted to regulatory agencies, both domestically and internationally, journal articles and/or other publications, abstracts of publications, published patent applications and issued patents, both domestic and international, financial filings, analyst call transcripts, press releases, and/or other types of documents that can provide valuable knowledge to various users for the various fields supported by the IACRP.

The knowledge graph includes connections between content items that facilitate rapid identification and analysis of content items included in the knowledge graph. The particular content items included in the knowledge graph may depend on the implementation of the IACRP and the particular fields supported by that implementation. In a non-limiting example, the knowledge graph includes information related to biopharmaceuticals for an implementation that supports analyzing information associated with biopharmaceuticals and generating content and/or recommending content based on this analysis to users of the IACRP.

To implement the connections between the content items in the knowledge graph, the content items are analyzed using an encoder-decoder model to generate embeddings representing the concepts or categories of information discussed in the content items. These embeddings are compared with a database of ontological information to identify related concepts or categories of information referred to herein as “ontological entities”. The ontological entities represent related concepts or categories that may be discussed in the content items that have been incorporated into the knowledge graph. These relationships can be used to identify potentially related content items in the knowledge graph that can be used to generate a response to a natural language query. The specific contents of the database of ontological information may vary from implementation to implementation. In a non-limiting example, the ontological database is a database of known ontological entities in implementations of the IACRP that support pharmaceuticals, medical devices, and/or other fields in which such entities are relevant. Other types of ontological entities are included in implementations of the IACRP that support other fields.

A shortlist of known entities is created using a vector search algorithm that compares the embedding vectors of the content item with embeddings associated with the known ontological entities. The shortlist is then verified to ensure that the entries included in the list are actually included in the content item using a confidence score matrix. The confidence score matrix is generated by combining the similarity score generated by the vector search algorithm for the content item and a known ontological entity from the shortlist with the last neural layer of the vector search algorithm. A connection between the content item and the known ontological entity is added to the knowledge graph in response to the confidence score matrix indicating that the content item includes a reference to the ontological entity. A technical benefit of this approach is that encoder-only models are used to perform the analysis, which provides more accurate results than current approaches that utilize decoder-only models to extract information from content items. The primary function of decoder-only models is the generation of new textual content. The decoder-only models tend to hallucinate and create ontological entities which are not present in the ontological database, thereby rendering any content generated based on this content to be incorrect. Consequently, the techniques provided herein can provide significantly more reliable results.

The IACRP queries the knowledge graph to identify content items that are relevant to the subject matter identified in an image of a document obtained by a user. The IACRP determines vector embeddings based on this subject matter. The vector embeddings are generated using the same encoder-decoder model used to generate the embeddings of the knowledge graph. The IACRP compares the vector embedding of the query with the vector embeddings of the content items included in the knowledge graph using a vector search. Consequently, the user does not need to perform the laborious and time-consuming manual process of formulating queries to multiple data sources in an attempt to retrieve relevant data. The techniques herein provide significant cost savings, time savings, and labor savings compared with the current manual and labor-intensive techniques of obtaining and analyzing such information. The techniques acquire and analyze data in minutes that would have previously taken a team of analysts hundreds of hours to complete using the current manual and labor-intensive techniques.

Another technical benefit of the IACRP utilizing the knowledge graph is that this approach provides traceability for the results generated based on the data included in the knowledge graph. The visualizations and/or other content generated by the IACRP using the information of the knowledge graph include citations to the source documents from which the model or models derived the information presented in the visualization or other content. Large Language Models (LLMs) and other such models can hallucinate results that are not grounded in reality when prompted for information that was not included in their training data. Such hallucinations are unacceptable for generating content that users would rely on to make important decisions. A technical benefit of the approach described in the present application is that all content generated using the techniques herein can be traced back to the source content item to ensure that the content is grounded. These and other technical benefits of the techniques disclosed herein will be evident from the discussion of the example implementations that follow.

The language model 174 is and encoder-decoder type machine learning model that is used by the content generation unit 170 to generate various types of content. The language model 174 may be implemented using the same model used to generate the knowledge graph by the knowledge graph unit 154, the knowledge graph builder model 302. In other implementation, the language model 174 is a separate model than the model used to generate the knowledge graph. In such implementations, the language model 174 is a model with an encoder-decoder architecture and may be implemented by an LLM or SLM. The content generation unit 170 and/or the request processing unit 152 construct natural language prompts that are submitted to the language model 174 to generate the content. The content generation unit 170 and/or request processing unit 152 format the prompt according to a prompt format expected by the language model 174. The prompt can include instructions to the language model 174 indicating the type of content to be generated and format for the content. The prompt can also include information to be analyzed by the language model 174.

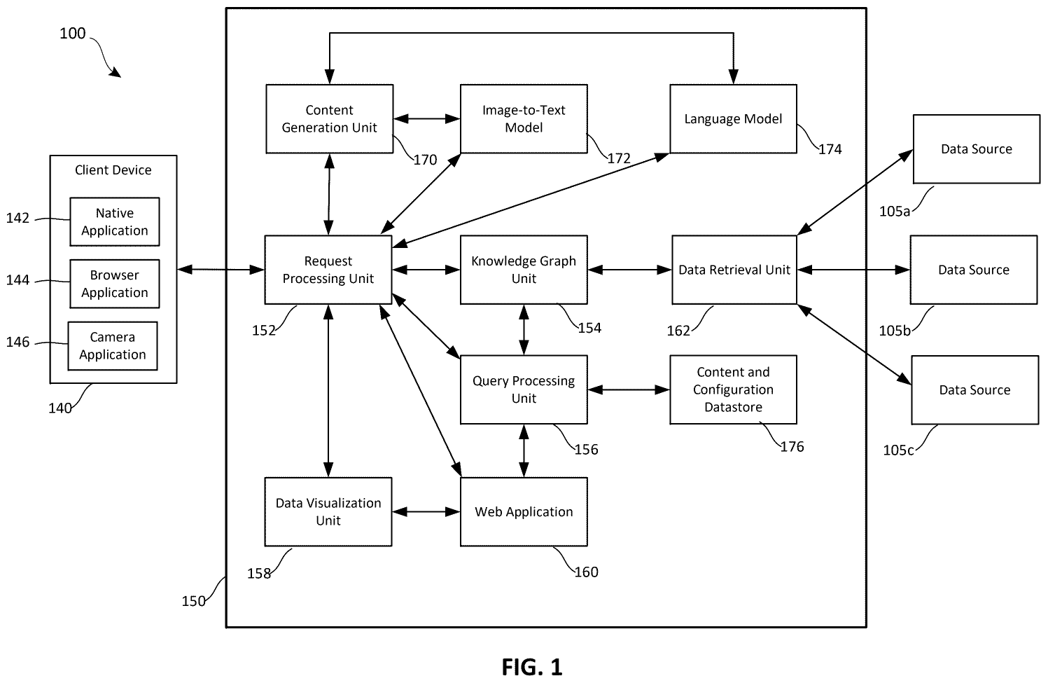

FIG. 1 is a diagram showing an example computing environment 100 in which the techniques for analyzing an image of a document to determine a subject matter of the document and rapidly acquiring, assessing, comparing, and analyzing the large volumes of data associated with the subject matter to generate content and recommendations for a user. The computing environment 100 includes an IACRP 150, data sources 105a, 105b, and 105c (collectively referred to as data source 105 herein), and client device 140. The IACRP 150 also includes request processing unit 152, data visualization unit 158, content generation unit 170, knowledge graph 154, query processing unit 156, web application 160, image-to-text model 172, language model 174, data retrieval unit 162, and a content and configuration datastore 176.

The IACRP 150 provides real time insights, trends, and recommendations to users interested in various fields, including but not limited to pharmaceuticals, biotechnology, medical devices, healthcare, materials science, finance, sports, and finance based on the subject matter of an image of document according to the techniques provided herein. This approach enables a user to capture an image of the document and obtain relevant information about the subject matter of the document in substantially real time. The IACRP 150 is implemented as a set of cloud-based services in some implementations, and the IACRP 150 communicates with the data sources 105a-105c and the client device 140 via a network. The network may be a dedicated private network, a public network, and/or the combination of public and private networks commonly referred to as the Internet.

The data sources 105a, 105b, and 105c provide electronic copies of various types of content, including but not limited to press releases, news articles, documents submitted to regulatory agencies both domestically and internationally, journal articles and/or other publications, abstracts of publications, published patent applications and issued patents both domestic and international, financial filings, analyst call transcripts, press releases, and/or other types of documents that may provide valuable cross-domain knowledge to various users within the pharmaceuticals, biotechnology, medical devices, healthcare, materials science, finance, sports, and finance and other such spaces. The data sources 105a, 105b, and 105c may include free data sources, subscription data sources, or a combination thereof. Whereas the example implementation shown in FIG. 1 includes three data sources, other implementations may include a different number of data sources.

The content items provided by the data sources 105a-105c include structured and/or unstructured documents. Structured documents, as used herein, refer to a document that includes some method of markup to identify elements of the document as having a specified meaning. The structured documents may be available in various domain-specific schemas, such as but not limited to Journal Article Tag Suite (JATS) for describing scientific literature published online, Text Encoding Initiative (TEI), and Extensible Markup Language (XML). Unstructured documents, also referred to as “free form” documents herein, are documents that do not include such markup to identify the components of the documents.

The data retrieval unit 162 obtains content items from the data sources 105a-105c and provides the content items to the knowledge graph builder unit 154 for analysis. The data retrieval unit 162 automatically accesses the data sources 105a-105c to check for new content items that have not yet been processed by the IACRP 150 and/or content items that have been updated since content items were last processed by the IACRP 150. In some implementations, the data retrieval unit 162 is configured to periodically check each of the data sources 105a-105c for new content or updates. The IACRP 150 provides a user interface for an administrator to configure the frequency at which the data retrieval unit 162 performs these checks. Some data sources 105 may have new content added more frequently than other data sources. Therefore, the IACRP 150 enables the administrator to select a frequency at which the data retrieval unit 162 checks for new content items and/or updated content items from each data source 105. The administrator can also specify a default frequency at which the data retrieval unit 162 checks with each data source 105 to determine whether any new content items have been added or existing content items have been updated.

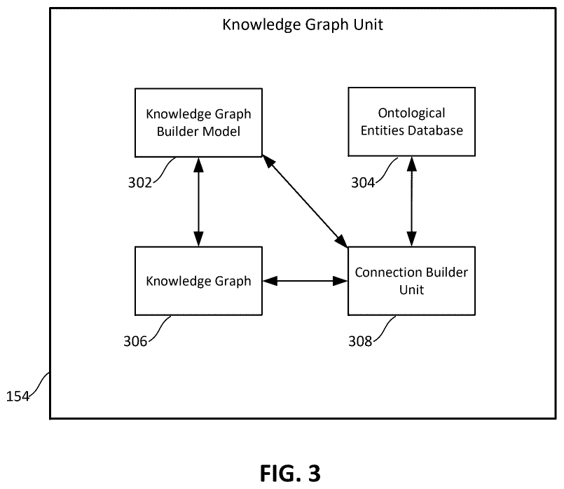

The data retrieval unit 162 is configured to analyze content items that include structured and/or unstructured documents. The data retrieval unit 162 is configured to extract data from the various content items and to convert the data to a standardized format or schema for processing by the knowledge graph builder model 302 of the knowledge graph unit 154. The knowledge graph builder model 302 is implemented by an LLM or a Small Language Model (SLM) in some implementations. The knowledge graph builder model 302 is implemented using a model that has an encoder-decoder model architecture to ensure that the model does not experience hallucinations and fabricate information. A technical benefit of this approach is that the LLM or SLM can be trained on data having this standardized format or schema, which can improve the inferences made by the models when analyzing data in this standardized format or schema. Consequently, the models can provide more consistent results when analyzing the content items obtained from the data sources 105 by the data retrieval unit 162. Additional details of the knowledge graph builder model 302 are discussed with respect to FIG. 3, which provides an example implementation of the knowledge graph unit 154.

The request processing unit 152 receives requests to obtain relevant content associated with an image of a document from the client device 140. A user of the client device can capture an image of a document using the camera application 146 of the client device 140 that can be used to control camera hardware of the client device 140. The client device 140 includes a native application 142 in some implementations that provides a user interface for presenting documents to the IACRP 150 for analysis and/or for formulating queries to present to the IACRP 150 to obtain visualizations and/or other content generated based on information obtained by querying the knowledge graph 306. In some implementations, the user may provide both an image of a document that is used to construct a query of the knowledge graph 306 and an indication of a format of the results of the query. The IACRP 150 provide means for the user to input a natural language query that is provided with the request and can be used when constructing an initial query that includes a document and/or as a follow up query to the initial query. The natural language query described additional query parameters to be utilized by the IACRP 150 when generating the visualizations and/or other content associated with the subject matter of the document captured in the image. The request processing unit 152 provides the image of the document to the image-to-text model 172. The image-to-text model 172 extracts textual content from an image of a document and/or analyzes other content included in the document, such as images, graphs, charts, tables, and/or other elements of the document to determine a subject matter of the document. The request processing unit 152 obtains the subject matter information extracted from the image of the document and provides the subject matter information to the query processing unit 156. The request processing unit 152 also provides the natural language query input by the user, if any, to the query processing unit 156.

The query processing unit 156 receives the subject matter information and the natural language query if one is provided. The query processing unit 156 may format or otherwise preprocess the subject matter information and/or the natural language query. The query processing unit 156 then provides the subject matter information and/or the natural language query to the knowledge graph unit 154 to obtain query embeddings. The subject matter information and/or the natural language query are provided to the knowledge graph builder model 302 as an input to obtain vector embeddings that represent the query to be performed on the knowledge graph 306. The query embeddings are generated in a similar manner as the embeddings for the content items included in the knowledge graph 306. The query processing unit 156 utilizes the query embeddings to search for relevant content items in the knowledge graph 306. The query processing unit 156 utilizes a vector search to search for relevant results based on a similarity of the vector embeddings and the embeddings of the content items. Furthermore, the connection information identified by the connection builder unit 308 may also be used to identify potentially relevant content items to include in the query results by identifying content items that are connected to the content items included in the query results. The query results are provided to the request processing unit 152, which then provides the query results to the content generation unit 170 and/or the data visualization unit 158 to generate various types of content and/or visualizations of the query results for the user of the client device 140.

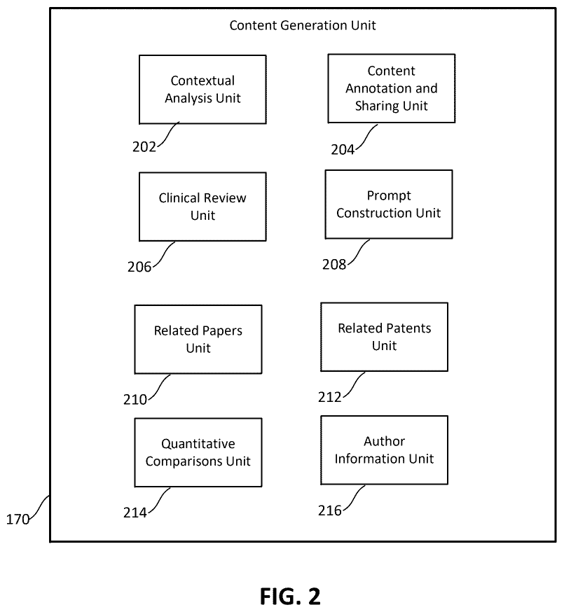

The content generation unit 170 receives the query results and generates one or more types of content in response to the query providing an image of a document and/or a natural language query. The content generation unit 170 can generate various types of content. Additional details of the content generation unit are discussed with respect to FIG. 2 which shows an example implementation of the content generation unit 170.

The data visualization unit 158 receives the data obtained from the query processing unit 156 and formats the data according to the indication as to how the data is to be presented to the user. The data may be presented to the user as various types of graphs, charts, tables, and/or text. In some implementations, the data visualization unit 158 generates a document that includes the query results in the requested format. In other implementations, the data visualization unit 158 generates web-based content that is accessible from the client device 140 via a web-enabled native application or web browser. Additional details and examples of how queries are processed, and how the rendering of the results are generated and presented on the client device 140 are provided in the examples which follow.

The client device 140 is a computing device that may be implemented as a portable electronic device, such as a mobile phone, a tablet computer, a laptop computer, a portable digital assistant device, and/or other such devices. The client device 140 may also be implemented in computing devices having other form factors, such as a desktop computer and/or other types of computing devices. While the example implementation illustrated in FIG. 1 includes a single client device, other implementations may include a different number of client devices that may utilize the services provided by the IACRP 150. Furthermore, in some implementations, some or all features of the services provided by the IACRP 150 may be implemented by a native application installed on the client device 140, and the native application may communicate with the data sources 105a, 105b, and 105c and/or the IACRP 150 over a network connection to exchange data with the data sources 105a, 105b, and 105c, and/or to access features implemented on the data sources 105a, 105b, and 105c and/or the IACRP 150. In some implementations, the client device 140 includes a native application 142 that is configured to communicate with the IACRP 150 to provide visualization and/or reporting functionality to the user of the client device. The native application 142 sends a request to the IACRP 150 that includes an image of a document and/or other query parameters to specify the format of the visualizations and/or reporting provided by the IACRP 150.

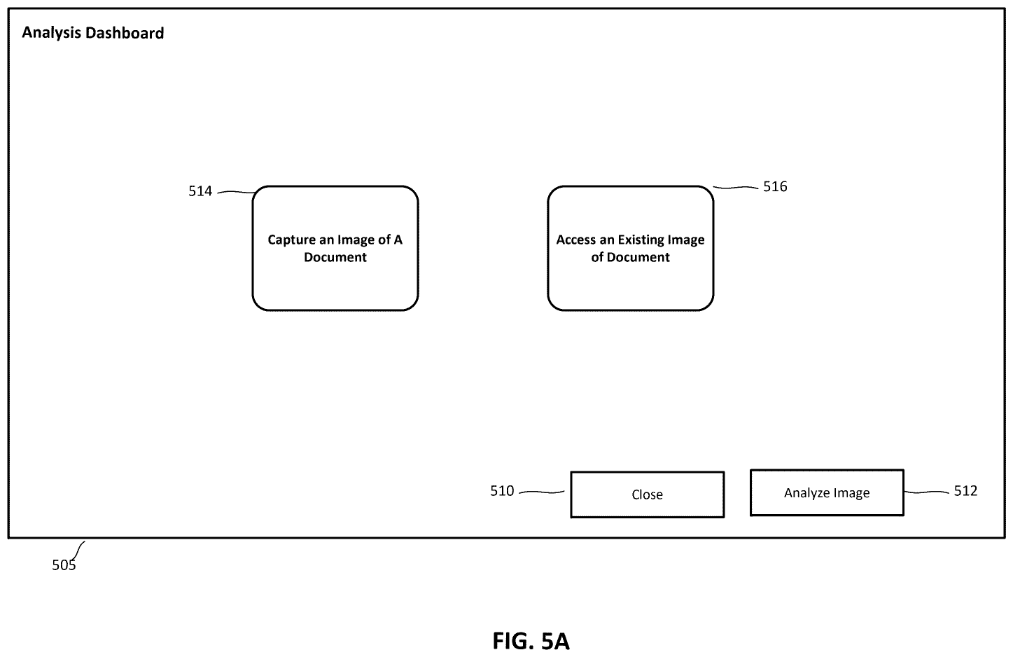

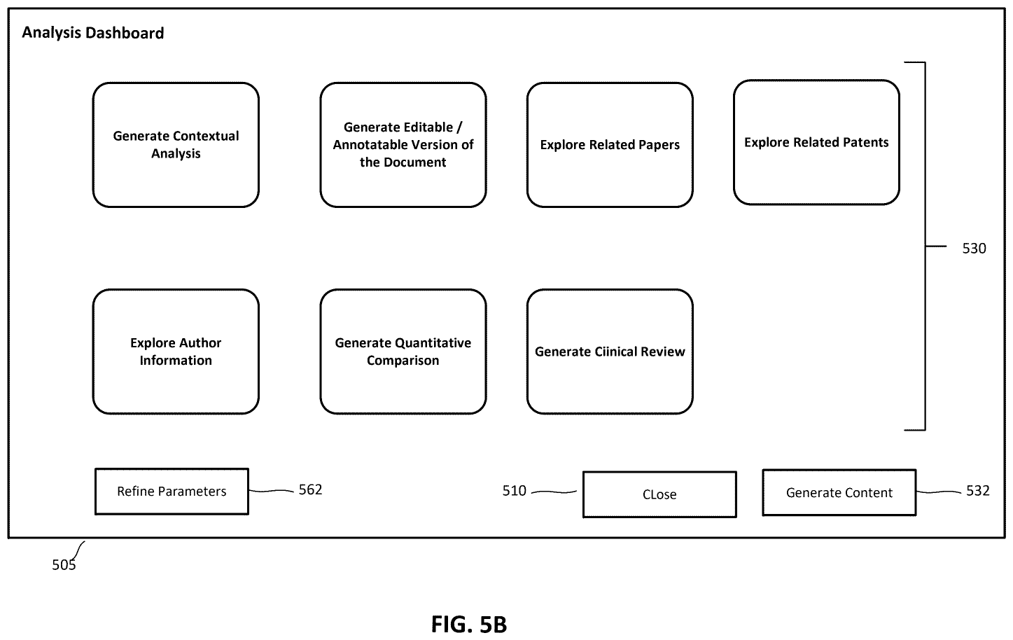

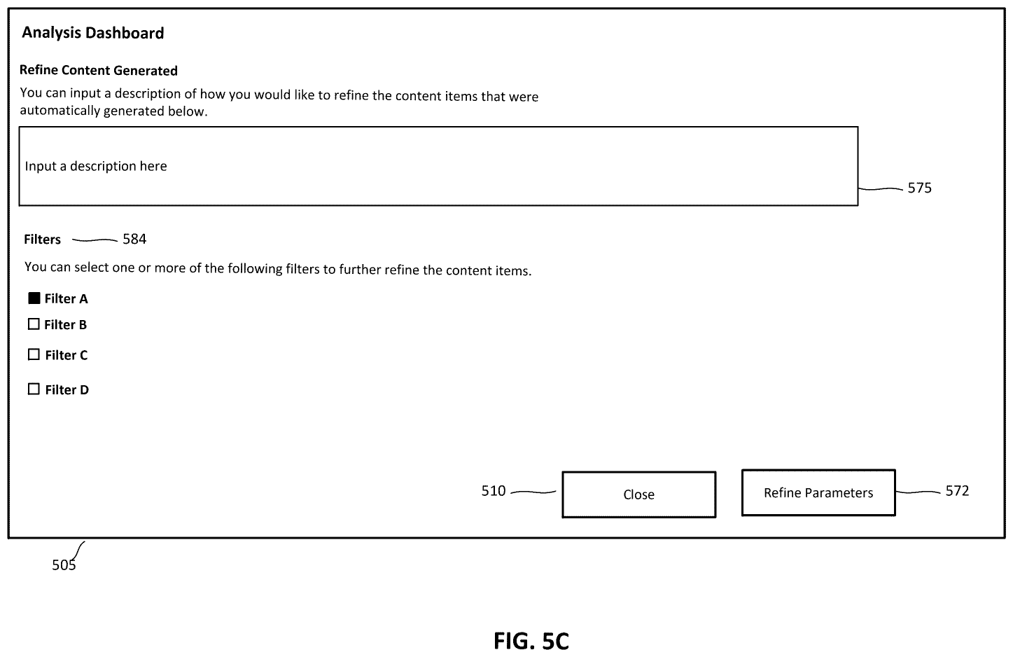

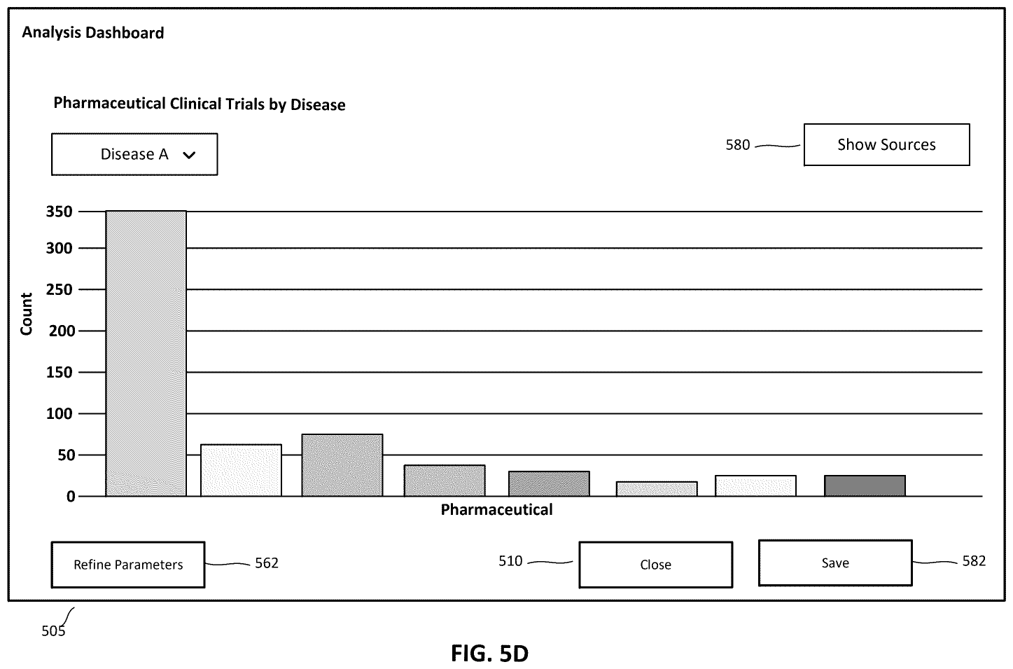

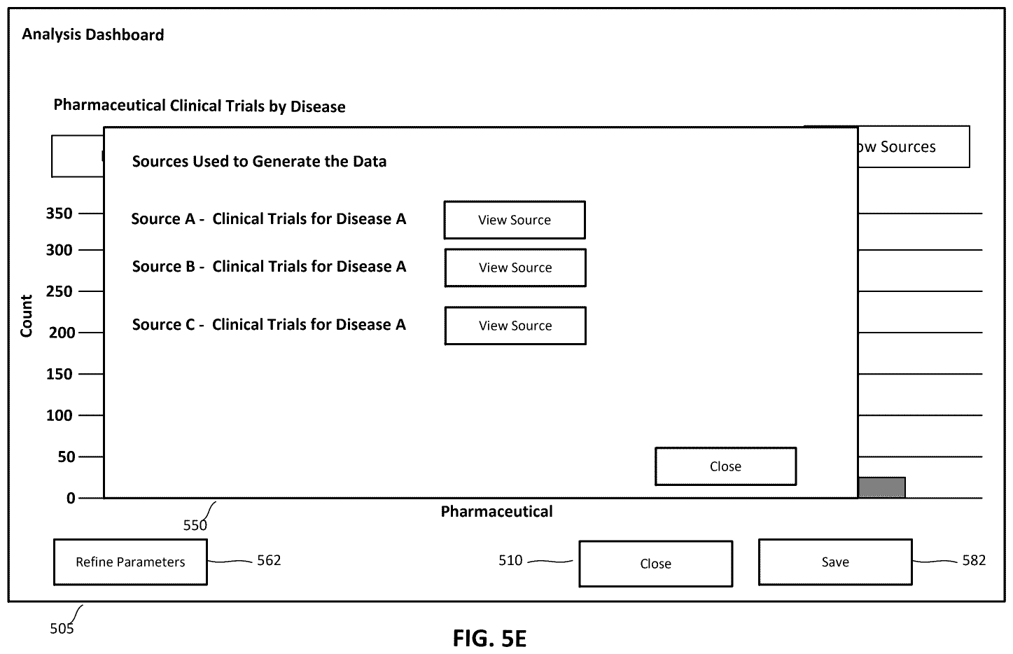

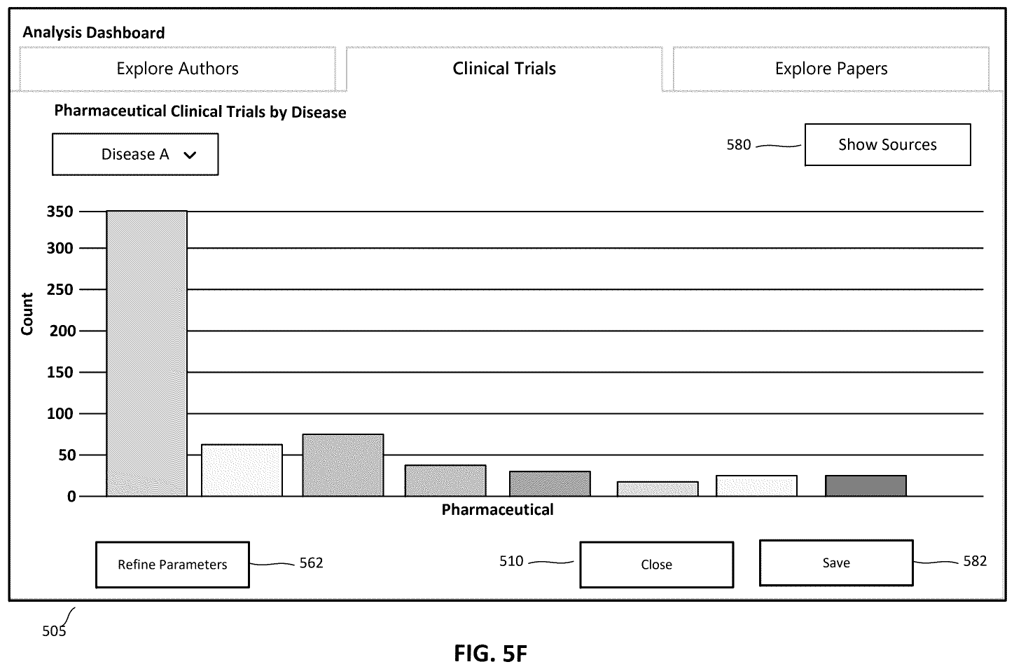

The IACRP 150 implements a web application 160, in some implementations, that can be accessed by a web-enabled native application 142 or browser application 144 on the client device 140. The web application 160 provide similar functionality as the native application 142. The web application provides the user interface 505 of FIGS. 5A-5F in such implementations and the user interface is presented to the user in the browser application 144 or native application 142 on the client device 140. In other implementations, the client device 140 includes a native application that renders the user interface 505 and the native application obtains the data to populate the user interface 505 from the IACRP 150.

The IACRP 150 also includes a content and configuration datastore 176. The content and configuration datastore 176 is a persistent datastore that is used by the IACRP 150 to store configuration data, user interface layout information and content for the web application 160, content and layout information used by the data visualization unit 158, and/or other content or configuration information that may be used by the various components of the IACRP 150.

FIG. 2 is a diagram of an example implementation of the content generation unit 170 shown in FIG. 1. The content generation unit 170 includes a contextual analysis unit 202, a content annotation and sharing unit 204, a clinical review unit 206, a prompt construction unit 208, a related papers unit 210, a related patents unit 212, a quantitative comparisons unit 214, and an author information unit 216. The content generation unit 170 receives the query results generated by the query processing unit 156 and generates various types of content from these query results using the language model 174. The content generation unit 170 can also process natural language prompts entered by a user of the client device 140 to refine the content generated by the content generation unit 170.

The contextual analysis unit 202 generates a contextual analysis of the subject matter identified in the document. The contextual analysis provides additional information about the subject matter of the document captured in the image. The contextual analysis includes content supporting a position of the author taken in the document as well as content supporting one or more alternate positions than that taken by the author. The information for the contextual analysis is obtained from the content items identified by the query processing unit 156. This approach provides the user with a balanced contextual analysis of the subject matter that is not limited to what was presented in the original document capture in the image.

The content annotation and sharing unit 204 is configured to generate an editable version of the document captured in an image. The context annotation and sharing unit 204 is configured to receive the textual content extracted from the image by the image-to-text model 172. The image-to-text model 172 also outputs formatting information that indicates the layout of the textual content, images, and/or other elements of the document. The content annotation and sharing unit 204 creates an editable version of the document that was captured in the image based on the textual content and the formatting information. The content annotation and sharing unit 204 provides the editable document to the web application 160 or the native application 142 to present to the user. The web application 160 or the native application 142 provide a user interface that enables the user to edit the editable document to add annotations and/or share the editable document with other users.

The clinical review unit 206 generates clinical reviews of indications, pharmaceuticals, medical devices, modes of actions, and/or companies and/or research institutions operating within a particular area for implementations of the IACRP 150 which supports queries in the pharmaceutical and/or medical device space. The clinical review unit 206 utilizes the language model 174 to summarize the query results into a report that can be presented to the user on a user interface of the native application 142 and/or the web application 160. The user interface includes controls for refining the query parameters, including and/or removing specific indications, pharmaceuticals, medical devices, modes of actions, and/or companies and/or research institutions to enable the user to further refine the clinical reviews.

The related papers unit 210 provides identifies papers related to the subject matter of the document and provides a summary of these papers. The related papers unit 210 obtains an electronic copy of papers that were determined to be relevant by the query processing unit 156. The knowledge graph 306 includes information that indicates a content source from which each of the content items can be retrieved. These content sources may be local to the IACRP 150 or may be network-accessible data sources that are located remotely from the IACRP 150. The related papers unit 210 uses this information to obtain a copy of each of the papers determined to be relevant. The related papers unit 210 then requests that the prompt construction unit 208 construct a prompt to the language model 174 for each paper requesting that the language model 174 generate a summary of the paper. The prompt construction unit 208 then submits the prompt for each paper to the language model 174 to obtain the summary of the paper.

The related patents unit 212 identifies domestic and/or foreign patents and published patent applications related to the subject matter of the document and provides a summary of these patents and/or patent applications. The related patents unit 212 obtains an electronic copy of patents and/or patent applications that were determined to be relevant by the query processing unit 156. The knowledge graph 306 includes information that indicates a content source from which each of the content items can be retrieved. The related patents unit 212 uses this information to obtain a copy of each of the patents and/or patent applications determined to be relevant. The related patents unit 212 then requests that the prompt construction unit 208 construct a prompt to the language model 174 for each patent and/or patent application requesting that the language model 174 generate a summary of the patent or patent application. The prompt construction unit 208 then submits the prompt for each patent and/or patent application to the language model 174 to obtain the summary of the patent and/or patent application.

The quantitative comparisons unit 214 generates quantitative comparisons from content items that analyze the same subject matter as that of the document captured in the image. The quantitative comparisons unit 214 provides the user with the ability to filter on the conditions that are included in the quantitative comparisons. In some implementations, the filter conditions are specified in a natural language query that is input by the user either before or after the quantitative comparison has been created. In instances in which the quantitative comparison has already been created, the user may enter a natural language query that specifies one or more filter conditions that can be used to narrow the scope of the quantitative comparison being generated. In a non-limiting example, the user captures an image of a document associated with Drug A. The quantitative comparisons unit 214 provides a user interface in which the user can apply filters on the performance of the drug by conditions of use, by patient demographics, and/or toxicity, the Absorption, Distribution, Metabolism, and Excretion (“ADME”) values of similar drugs, studies of biomarkers, market performance, and/or other such filters that enable the user to narrow the scope of the quantitative comparison generated for Drug A. The specific filters that are available vary depending upon the specific implementation and the subject matter of the quantitative comparison.

The author information unit 216 generates information about the authors of the document captured in the image including other publications and/or projects on which the authors have participated. The author information may be generated from the knowledge graph 306. The knowledge graph 306 may include numerous articles, papers, blog posts, and/or other sources of information about the authors of the document. The author information unit 216 provides the relevant content items obtained from the query processing unit 156 to the prompt construction unit 208 to construct a prompt to the language model 174 to summarize the information about the authors. The prompt construction unit 208 then submits the prompt to the language model 174 to obtain the summary of the information for each of the authors of the document captured in the image by the user.

The prompt construction unit 208 constructs prompts for the language model 174 to cause the language model 174 to generate content for the various components of the content generation unit 170. The prompt includes content to be summarized, analyzed, refined, or otherwise processed by the language model 174. The prompt construction unit 208 submits the prompt to the language model 174 and receives the response from the language model 174. The prompt construction unit 208 formats or otherwise processes the response received from the language model 174 before providing the unit or units of the content generation unit 170 for processing in some implementations.

FIG. 3 is a diagram of an example knowledge graph unit 154 shown in FIG. 1. The knowledge graph unit includes the knowledge graph builder model 302, the ontological entities database 304, the knowledge graph 306, and the connection builder unit 308.

The knowledge graph builder model 302 receives content items from the data retrieval unit 162 that either have not yet been processed by the IACRP 150 or have been updated since the content item was last processed. The knowledge graph builder model 302 is an LLM or SLM that uses an encoder-decoder architecture. The encoder of the knowledge graph builder model 302 is used to generate embedding vectors that represent each of the content items. In some implementations, the knowledge graph builder model 302 implements a bidirectional encoder representation from a transformer algorithm to generate the embeddings. The embedding vectors generated by the knowledge graph builder model 302 are used to create the knowledge graph 306. A technical benefit of the knowledge graph builder model is that the model may be implemented by a smaller LLM or SLM that requires significantly fewer computing resources to implement than the larger LLM. Consequently, the resources required to analyze the large volume of data provided by the data sources 105 can be significantly reduced by using smaller LLM or SLM to generate the vector embeddings without significantly impacting the performance of the model. The knowledge graph 306 is based on embedding vectors representing the content items that have been encoded by the knowledge graph builder model 302. The vector embeddings facilitate searching the vast amount of content items from the data sources 105 that have been analyzed by the knowledge graph builder model 302.

The knowledge graph 306 also includes connection information that identifies connections between content items included in the knowledge graph and known ontological entities from the ontological entities database 304. The known ontological entities are a curated list of ontological entities that are relevant for various fields supported by the IACRP 150. For example, the ontological entities database 304 may include ontological entities include but not limited to diseases, biomarkers, mechanisms of action, and/or other entities that may be relevant to the development of pharmaceuticals and/or medical devices for implementations that support the fields of pharmaceuticals and/or medical devices. The connections facilitate rapid identification and analysis of content items included in the knowledge graph when generating content based on the knowledge graph. To implement these connections, the connection builder unit 308 compares the embeddings included in the knowledge graph 306 for a particular content item with the ontological entities included in the database 304 to create a shortlist of known ontological entities. The ontological entities represent concepts or categories of information that may be discussed in the content items that have been incorporated into the knowledge graph 306. These relationships can be used to identify potentially relevant content items in the knowledge graph that can be used to generate a response to a natural language query. The connection builder unit 308 creates the shortlist of known ontological entities using a vector search algorithm that compares the embedding vectors of the content item with embeddings associated with the known ontological entities. The connection builder unit 308 then performs a relevance check on the shortlist of candidate ontological entities to ensure that the ontological entities included in the shortlist are actually included in the content item. The connection builder unit 308 uses a confidence score matrix to make the determination whether the ontological entries from the shortlist are included in the content item. The shortlist is then verified to ensure that the entries included in the list are actually included in the content item using a confidence score matrix to generate a final confidence score for each entry in the shortlist. The connection builder unit 308 adds a connection between the content item and the known ontological entity to the knowledge graph in response to the final confidence score indicating that the content item includes a reference to the ontological entity. A technical benefit of this approach is that encoder-only models are used for this process. Current approaches for extracting information from content items utilize decoder-only models. The primary purpose of such decoder-only models is the generation of new textual content, which can result in hallucinations in which the model creates entities which are not present in the ontological database, thereby rendering any content generated based on this content to be incorrect. The encoder-only approach taken by the techniques provided herein cannot result in such hallucinations. Consequently, the techniques provided herein can provide significantly more reliable results.

The knowledge graph 306 can also include additional information, such as but not limited to content item source information that is used to enable visualization and/or other content generated by the IACRP 150 to be traced back to the source content items to ensure that the content is grounded. As will be discussed in the examples that follow, the various user interfaces provided by the IACRP 150 provide the user with the ability to view the source content item information and/or obtain copies of the content items. The knowledge graph 306 is stored in a persistent datastore of the IACRP 150 and can be accessed and/or updated by the components of the IACRP 150 discussed herein. The knowledge graph 306 can be leveraged to generate visualizations and/or other content based on known relationships between certain categories of data encoded by the models. The knowledge graph builder model 302 is trained to recognize certain categories of information in the content items, in some implementations, to facilitate linking content items that have been included in the knowledge graph 306. In a non-limiting example, one category of information is categories of diseases, and another category of information is the biomarkers associated with these diseases that are detected when a therapy is working or when a therapy is not working. Other categories of information may be the companies or other organizations that are involved in testing pharmaceuticals for these categories of diseases and/or for specific mechanisms of actions. As discussed in the preceding examples, the specific categories of information included in the knowledge graph can vary from implementation to implementation of the IACRP 150. The model or models used to generate the knowledge graph 306 are trained to recognize these and other categories of information that are relevant to pharmaceutical and/or medical device development and to include this information in the embeddings associated with the content items where applicable. A technical benefit of this approach is that the relationships between the various relevant categories of information can be quickly explored in the knowledge graph 306 to automatically generate visualizations and/or other content that would have otherwise required labor-intensive manual queries to numerous data sources and subsequent analysis of the data obtained to attempt to identify relevant information. For complex problems, the gathering and analysis of such information may take days or even months. The IACRP 150 facilitates generation of this information in a matter of minutes or less. Consequently, the resources that would have been directed to the manual gathering and analysis of this information can be directed to other productive endeavors.

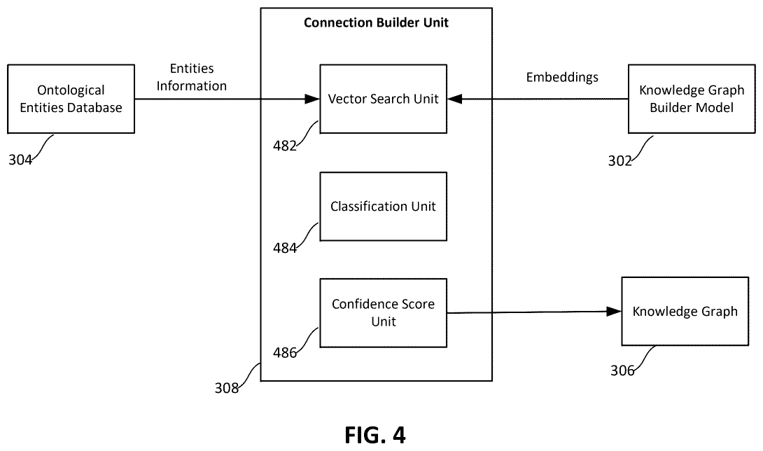

FIG. 4 is a diagram showing additional details of the connection builder unit 308 shown in FIG. 3. The connection builder unit 308 includes a vector search unit 482, a classification unit 484, and a confidence score unit 486. The vector search unit 482 performs a vector search on the ontological entities database 304 which contains information for known ontological entities. The known ontological entities represent related concepts or categories that may be discussed in the content items that have been incorporated into the knowledge graph. These relationships can be used to identify potentially relevant content items in the knowledge graph that can be used to generate a response to a query for content items that are associated with a particular subject matter identified in a document captured in an image by a user of a client device 140.

The vector search unit 482 receives embedding vectors from the knowledge graph builder model 302 and conducts a search for known ontological entities in the ontological entities database 304. The vector search unit 482 conducts this search using a vector search algorithm to identify potentially matching known ontological entities based on the similarity of the embeddings associated with the content items received from the knowledge graph builder model 302 and the embeddings associated with the known ontological entities in the ontological entities database 304. The vector search unit 482 generates a shortlist of known ontological entities for each content item.

The classification unit 484 analyzes the shortlist of known ontological entities for each content item. The classification unit 484 includes an encoder neural network configured to classify whether the potentially matching ontological entities included in the shortlist identified by the vector search module are actually present in the text of the content item. The classification unit concatenates the text of the content item and the potentially matching ontological entities from the shortlist. In some implementations, the classification unit 484 is a multi-layer perceptron encoder neural network.

The confidence score unit 486 determines a final confidence score for each of the potentially matching ontological entities from the shortlist. The final confidence score for a respective potentially matching ontological entity indicates whether the text of the content item includes a reference to the respective potentially matching ontological entity. If the final confidence score for the respective potentially matching ontological entity satisfies a predetermined threshold, the connection builder unit 308 adds a connection between the ontological entity and the content item. This process is repeated for each of the candidate ontological entities included in the shortlist.

The confidence score unit 486 implements a confidence score matrix to make the determination whether the ontological entries from the shortlist are included in the content item. The confidence score matrix generates a final confidence score for each potentially matching ontological entity by combining: (1) the similarity score generated by the vector search algorithm for the content item and the potentially matching ontological entity, and (2) an output from a last layer of the encoder neural network of the classification unit 484. A technical benefit of this approach is that the models used are encoder-based and avoid the problem of hallucination of ontological entities not included in the ontological entities database 304.

FIGS. 5A-5E show an example user interface 505 that can be implemented by the native application 142 and/or the web application 160. FIGS. 5A-5E provide non-limiting examples of the types of information and controls that may be presented to users of the native application 142 and/or the web application 160. Other implementations may provide a different functionality associated with different controls and/or content.

FIG. 5A shows an example of the user interface 505 presenting a query whether the user would like to capture and analyze an image of a document and/or utilize a previously captured image of the document. The user can click on or otherwise activate the control 514 to cause the native application 142 or the camera application 146 to capture an image of a document using the camera hardware of the client device 140. The user can click on or otherwise activate the control 516 to cause the native application 142 and/or the web application 160 to present a file selection pane (not shown) that enables the user to select an image file stored on the client device 140 and/or the IACRP 150. The user may click on the close control 510 to close the user interface or the analyze image control 512 to cause the IACRP 150 to analyze the image of the document that has been captured or accessed via the user interface 505.

FIG. 5B shows an example of the user interface 505 which presents a set of content items 530 that can be generated by the IACRP 150 in response to the user capturing a photo of a document and/or accessing a previously captured photo of the document. The specific types of content items that can be generated by the IACRP 150 may vary depending upon the particular implementation of the IACRP 150 and the subject matter of the document. The example content items shown in FIG. 5B are examples of the types of content items that may be presented to a user in response to the user requesting an image of a document related to a pharmaceutical be analyzed. Other implementations may real time insights, trends, and recommendations to users interested in other fields, including but not limited to biotechnology, medical devices, healthcare, materials science, finance, sports, and finance. The user can select click on or otherwise select one or more of the content items from the set of content items 530 and click or otherwise activate the generate content control 532. The user may alternatively click on or otherwise activate the close control 510 to close the user interface 505. The user may also click on or otherwise activate the refine parameters control 562 to cause the user interface 505 to present the user with options for refining the search results as shown in FIG. 5C.

FIG. 5C show an example of the user interface 505 in which the user interface presents controls that enable the user to input natural language queries and/or select filters that the content generated by the IACRP 150 to be refined. The user may enter a natural language description of how the user would like to refine the content items in the prompt field 575. The user may can describe in natural language The user may also select one or more of the filters 584 to be applied. The filters are automatically generated by the IACRP 150 based on the type of content items that were generated and/or the subject matter of the document which the user has requested be analyzed. Accordingly, the filters presented for a document related to pharmaceuticals may be very different than the filters related to a document related to finance. The user can click on or otherwise activate the refine parameters control 572 to cause the native application 142 and/or the web application 160 to present the natural language query and/or filters to the request processing unit 152. The request processing unit 152 then provides the natural language query and/or filters to the content generation unit 170. The prompt construction unit 208 receives the natural language query and/or the filters information and constructs a prompt to the language model 174 to refine the one or more content items. The natural language query may specific a specific content item to be revised in instances in which the user had requested that multiple content items be generated in FIG. 5B.

FIG. 5D shows an example of the user interface 505 in which the user has selected the clinical trial content item shown in FIG. 5B. The user can click on or otherwise activate the save control 582 to cause the IACRP 150 to save a copy of the content generated by the content generation unit 170. The user can click on or otherwise activate the show sources control 580 to cause the source information to be displayed for the content items used to generate the content presented by the module.

FIG. 5E shows an example source information pane 550 that includes example source information that provides grounding for the content presented by the module. The source information pane 550 also provides controls, when activated, cause the content item to be presented to the user. The request processing unit 152 can request that the data retrieval unit 162 obtain a copy of the content item from the data source 105 from which the content item was originally obtained and analyzed for inclusion in the knowledge graph 306. A technical benefit of this approach is that the user can readily access grounding information that verifies that the content presented by the model is accurate according to the original source documentation and has not been hallucinated by the language model.

FIG. 5F shows an example of the user interface 505 which include tabs for presenting more than content item to the user in response to the user selecting multiple content items from the set of content items shown in FIG. 5B.

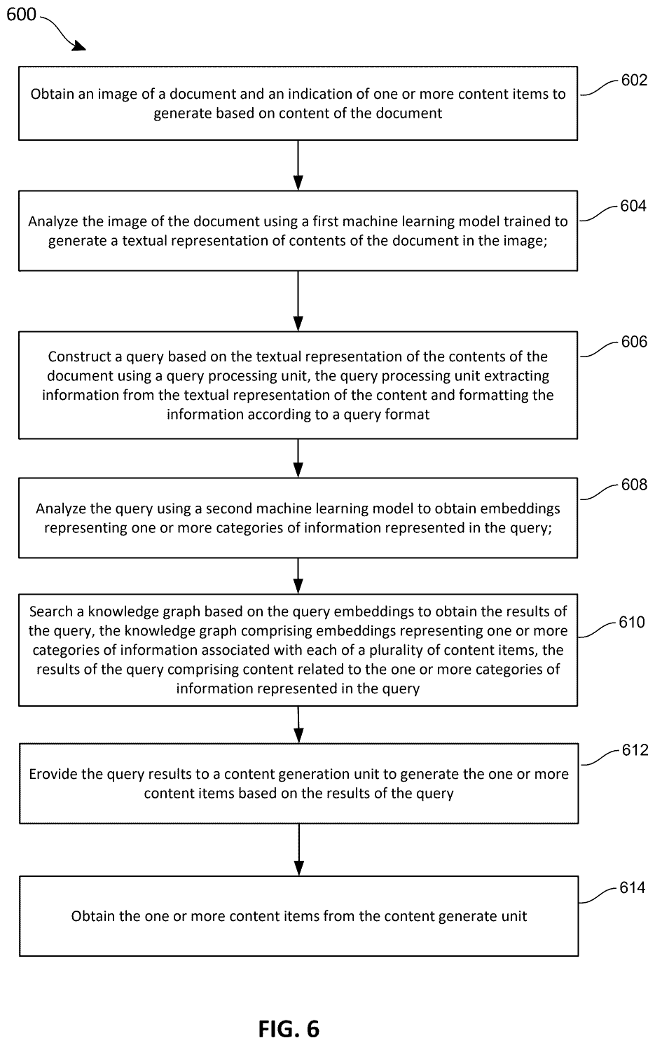

FIG. 6 is a flow chart of an example process 600 for generating content according to the technique herein. The process 600 is implemented by the IACRP 150, in some implementations. The process 600 implements the techniques for generating various types of content based on an image of a document captured by a client device, such as the client device 140.

The process 600 includes an operation 602 of obtaining an image of a document and an indication of one or more content items to generate based on content of the document. The image of the document can be captured using a camera of a client device, such as the client device 140. The camera includes a camera application 146 that enables images to be captured using camera hardware of the client device 140. The native application 142 may also include functionality that enables the application to capture an image using the camera hardware of the client device 140 in some implementations. The native application 142 and/or the web application 160 can provide the image of the document to the request processing unit 152 of the IACRP 150 for processing. In some implementations, the image of the document may have been captured in advance and stored n the client device 140 and/or the IACRP 150, and the native application 142 and/or the web application 160 provide a user interface that enables the user of the client device 140 to select from among photos that have been stored on the client device 140 and/or the IACRP 150. In some instances, the document may include multiple pages that have been captured in multiple images.

The process 600 includes an operation 604 of analyzing the image of the document using a first machine learning model trained to generate a textual representation of contents of the document in the image. As discussed in the preceding examples, the image-to-text model 172 analyzes the image to extract textual content of the document from the document. This extraction process can include text recognition and/or recognition of images included in the document. The resulting textual content represents the subject matter of the document. In instance in which multiple images of a document are obtained, each of the images are processed by the image-to-text model 172 to extract textual content from the images. In some implementations, the image of the document is analyzed using an image-to-text model, such as the image-to-text model 172, to extract text from the image of the document, and the text from the image of the document is then analyzed by a language model, such as the knowledge graph builder model 302 to obtain a textual representation of the document in the image. As discussed in the preceding examples the knowledge graph builder model 302 is implementing using an LLM or SLM in some implementations, and the knowledge graph builder model 302 can be used to perform various tasks in addition to generating embeddings by constructing a prompt to instruct the knowledge graph builder model 302 to analyze the textual content and perform various actions on this content. Furthermore, in some implementations, the language model 174 may be implemented using the same model as the knowledge graph builder model 302.

The process 600 includes an operation 606 of constructing a query based on the textual representation of the contents of the document using a query processing unit 156. The query processing unit 156 extracts information from the textual representation of the content and formatting the information according to a query format.

The process 600 includes an operation 608 of analyzing the query using a second machine learning model to obtain embeddings representing one or more categories of information represented in the query. The query processing unit 156 obtains the embeddings from the knowledge graph builder model 302, which is the model that was used to build the knowledge graph 306. The query processing unit 156 utilizes the query embeddings to search for relevant content items in the knowledge graph 306. The query processing unit 156 utilizes a vector search to search for relevant results based on a similarity of the vector embeddings and the embeddings of the content items. As discussed above, the first machine learning model and the second machine learning model are the same model in some implementation and are different models in other implementations.

The process 600 includes an operation 610 of searching a knowledge graph 306 based on the query embeddings to obtain the results of the query. The knowledge graph 306 comprising embeddings representing one or more categories of information associated with each of a plurality of content items. The results of the query include content related to the one or more categories of information represented in the query.

The process 600 includes an operation 612 of providing the query results to a content generation unit to generate the one or more content items based on the results of the query and an operation 614 of obtaining the one or more content items from the content generate unit. The content generation unit 170 generates the one or more content items requested by the user based on the content generated by the language model 174 using the various units of the content generation unit 170.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

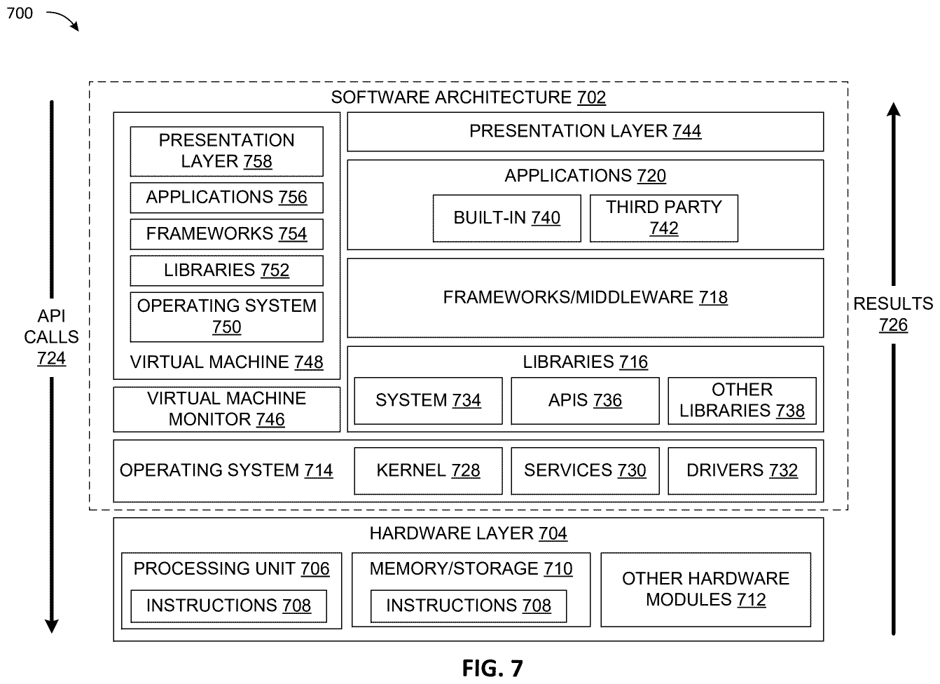

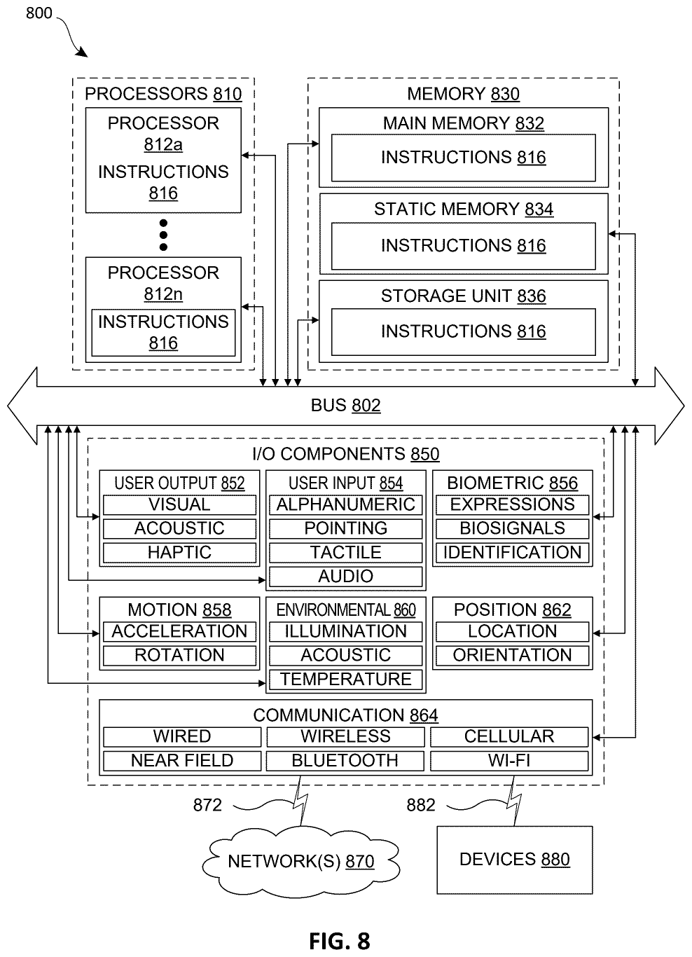

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable medium storing executable instructions that, when executed, cause the processor alone or in combination with other processors to perform operations comprising:
obtaining an image of a document and an indication of one or more content items to generate based on content of the document;
analyzing the image of the document using a first machine learning model trained to generate a textual representation of contents of the document in the image;
constructing a query based on the textual representation of the contents of the document using a query processing unit, the query processing unit extracting information from the textual representation of the content and formatting the information according to a query format;
analyzing the query using a second machine learning model to obtain embeddings representing one or more categories of information represented in the query;
searching a knowledge graph based on the query embeddings to obtain results of the query, the knowledge graph comprising embeddings representing one or more categories of information associated with each of a plurality of content items, the results of the query comprising content related to the one or more categories of information represented in the query;
providing the query results to a content generation unit to generate the one or more content items based on the results of the query; and
obtaining the one or more content items from the content generate unit.

2. The data processing system of claim 1, wherein the second machine learning model is a Large Language Model (LLM) or Small Language Model (SLM), the second machine learning model having an encoder-decoder architecture.

3. The data processing system of claim 1, further comprising:
constructing one or more first prompts to a third machine learning model using the content generation unit;
providing the one or more first prompts to the third machine learning model to obtain first generated textual content;
obtaining the first generated textual content at the content generation unit; and
generating the one or more content based on the first generated textual content.

4. The data processing system of claim 3, wherein the third machine learning model is a Large Language Model (LLM) or Small Language Model (SLM), the third machine learning model having an encoder-decoder architecture.

5. The data processing system of claim 3, wherein the machine-readable storage medium further includes instructions configured to cause the processor alone or in combination with other processors to perform operations of:
causing a user interface of an application on a client device to present the one or more content items.

6. The data processing system of claim 5, wherein the machine-readable storage medium further includes instructions configured to cause the processor alone or in combination with other processors to perform operations of:
receiving a natural language query from the application on the client device, the natural language query requesting that a specified content item of the one or more content items be further refined;
constructing a second prompt to the third machine learning model to refine the specified content item;
providing the one or more first prompts to the third machine learning model to obtain second generated textual content;
obtaining the second generated textual content at the content generation unit; and
generating a refined version of the specified content item based on the second generated textual content.

7. The data processing system of claim 5, wherein the machine-readable storage medium further includes instructions configured to cause the processor alone or in combination with other processors to perform operations of:
receiving a request from the application on the client device to further refine the one or more content items according to one or more filters;
constructing a second prompt to the third machine learning model to refine the specified content item according to the one or more filters;
providing the one or more first prompts to the third machine learning model to obtain second generated textual content;
obtaining the second generated textual content at the content generation unit; and
generating a refined version of the specified content item based on the second generated textual content.

8. The data processing system of claim 5, wherein the user interface is a dashboard user interface that presents the one or more content items and includes controls for viewing each of the one or more content items.

9. The data processing system of claim 3, wherein the second machine learning model and the third machine learning model are the same machine learning model.

10. The data processing system of claim 3, wherein the second machine learning model and the third machine learning model are different machine learning models.

11. The data processing system of claim 1, wherein searching the knowledge graph based on the query embeddings to obtain the results of the query comprises searching the knowledge graph using a vector search.

12. The data processing system of claim 1, wherein the document is a slide, poster, or paper.

13. A method implemented in a data processing system for generating electronic content, the method comprising:
obtaining an image of a document and an indication of one or more content items to generate based on content of the document;
analyzing the image of the document using a first machine learning model trained to generate a textual representation of contents of the document in the image;
constructing a query based on the textual representation of the contents of the document using a query processing unit, the query processing unit extracting information from the textual representation of the content and formatting the information according to a query format;
analyzing the query using a second machine learning model to obtain embeddings representing one or more categories of information represented in the query;
searching a knowledge graph based on the query embeddings to obtain results of the query, the knowledge graph comprising embeddings representing one or more categories of information associated with each of a plurality of content items, the results of the query comprising content related to the one or more categories of information represented in the query;
providing the query results to a content generation unit to generate the one or more content items based on the results of the query; and
obtaining the one or more content items from the content generate unit.

14. The method of claim 13, wherein the second machine learning model is a Large Language Model (LLM) or Small Language Model (SLM), the second machine learning model having an encoder-decoder architecture.

15. The method of claim 13, further comprising:
constructing one or more first prompts to a third machine learning model using the content generation unit;
providing the one or more first prompts to the third machine learning model to obtain first generated textual content;
obtaining the first generated textual content at the content generation unit; and
generating the one or more content based on the first generated textual content.

16. The method of claim 13, wherein the third machine learning model is a Large Language Model (LLM) or Small Language Model (SLM), the third machine learning model having an encoder-decoder architecture.

17. The method of claim 13, further comprising:
causing a user interface of an application on a client device to present the one or more content.

18. The method of claim 15, further comprising:
receiving a natural language query from the application on the client device, the natural language query requesting that a specified content item of the one or more content items be further refined;
constructing a second prompt to the third machine learning model to refine the specified content item;
providing the one or more first prompts to the third machine learning model to obtain second generated textual content;
obtaining the second generated textual content at the content generation unit; and
generating a refined version of the specified content item based on the second generated textual content.

19. The method of claim 15, further comprising:
receiving a request from the application on the client device to further refine the one or more content items according to one or more filters;
constructing a second prompt to the third machine learning model to refine the specified content item according to the one or more filters;
providing the one or more first prompts to the third machine learning model to obtain second generated textual content;
obtaining the second generated textual content at the content generation unit; and
generating a refined version of the specified content item based on the second generated textual content.

20. The method of claim 11, wherein the document is a slide, poster, or paper.
